(19) United States
(12) Patent Application Publication
(10) Pub. No.: US 2026/0357449 A1
(43) Pub. Date: Nov. 12, 2026

(54) FILM PRODUCTION METHOD AND POLYMER ELECTROLYTE MEMBRANE PRODUCTION METHOD

(71) Applicant: AGC Inc., Tokyo (JP)

(72) Inventors: Shintaro HAYABE, Tokyo (JP); Tetsuo ABE, Tokyo (JP); Takumi OKUYAMA, Tokyo (JP); Toshiaki SAWADA, Tokyo (JP)

(73) Assignee: AGC Inc., Tokyo (JP)

(21) Appl. No.: 19/709,837

(22) Filed: Jun. 16, 2026

Related U.S. Application Data
(63) Continuation of application No. PCT/JP2024/046042, filed on Dec. 25, 2024.

(30) Foreign Application Priority Data
Dec. 28, 2023 (JP) 2023-222993

(51) Int. Cl. C25B 9/23; C25B 1/04; C25B 11/093; C25B 13/08

(52) U.S. Cl. CPC C25B 9/23; C25B 1/04; C25B 11/093; C25B 13/08

(57) ABSTRACT

To provide a film production method by which it is possible to produce a film containing at least one type of additive selected from the group consisting of a platinum-containing material and cerium oxide, with suppressed formation of pinholes. A film production method, which comprises melting a fluorinated polymer having units based on tetrafluoroethylene and having groups convertible to ion exchange groups, and passing the melt through a filter X to prepare first pellets; using the first pellets and at least one type of additive selected from the group consisting of a platinum-containing material and cerium oxide, to obtain a melt containing the additive and the fluorinated polymer, and not passing the melt through a filter or passing the melt through a filter Y having a pore size larger than 5 times the volume-based cumulative 50% size of the additive, to prepare second pellets containing the additive; and conducting melt-extrusion using the first pellets and the second pellets to produce a film containing the fluorinated polymer and the additive.

### TECHNICAL FIELD

The present disclosure relates to a film production method and a polymer electrolyte membrane production method.

### BACKGROUND ART

In the so-called power-to-gas technology for storing and using surplus electric power by converting it to gas, the utilization of polymer electrolyte membrane water electrolyzers (PEM water electrolyzers) has been explored.

In a PEM water electrolyzer, reduction of generated hydrogen crossover is required. Herein, hydrogen crossover refers to a phenomenon where, in a PEM water electrolyzer, hydrogen gas generated at a cathode transfers to an anode side through a polymer electrolyte membrane. The occurrence of hydrogen crossover results in a problem of deterioration in hydrogen gas recovery efficiency.

As a means to reduce such crossover, Patent Document 1 discloses a catalyst-coated membrane comprising a membrane containing a cathode catalyst layer, a membrane containing an anode catalyst layer, and a membrane containing a recombination catalyst layer. In the catalyst-coated membrane, the membrane containing the recombination catalyst layer is arranged between the membrane containing the cathode catalyst layer and the membrane containing the anode catalyst layer. As the recombination catalyst, for example, a catalyst material containing platinum is disclosed.

### PRIOR ART DOCUMENTS

### Patent Documents

Patent Document 1: JP-A-2020-514528

### DISCLOSURE OF INVENTION

### Technical Problem

Patent Document 1 also discloses to incorporate into any of the above membranes a cerium oxide-containing catalyst as a hydrogen peroxide scavenger catalyst.

For more efficient production of polymer electrolyte membranes (films), the present inventors have conducted studies on film production by preparing pellets containing a fluorinated polymer and at least one type of additive selected from the group consisting of a platinum-containing material and cerium oxide, and using the pellets to produce a film. When a film was to be produced by extrusion using the pellets, there were a case where no film could be formed and a case where the formed film had pinholes.

The present invention had been made to solve the above problems, and according to an embodiment of the present invention, the object is to provide a film production method by which it is possible to produce a film containing at least one type of additive selected from the group consisting of a platinum-containing material and cerium oxide, with suppressed formation of pinholes.

According to an embodiment of the present invention, another object is to provide a polymer electrolyte membrane production method.

### Solution to Problem

The present disclosure includes the following configurations.

[1]

A film production method, which comprises melting a fluorinated polymer having units based on tetrafluoroethylene and having groups convertible to ion exchange groups, and passing the melt through a filter X to prepare first pellets,
using the first pellets and at least one type of additive selected from the group consisting of a platinum-containing material and cerium oxide to obtain a melt containing the additive and the fluorinated polymer, and not passing the melt through a filter or passing the melt through a filter Y having a pore size larger than 5 times the volume-based cumulative 50% size of the additive, to prepare second pellets containing the additive, and
conducting melt-extrusion using the first pellets and the second pellets to produce a film containing the fluorinated polymer and the additive.
   [2]

The film production method according to [1], wherein the second pellets contain both the platinum-containing material and the cerium oxide.

[3]

The film production method according to [1] or [2], wherein in the melt-extrusion, two or more types of the second pellets are used,
at least one type of the second pellets contain only the platinum-containing material, and
at least one type of the second pellets contain only the cerium oxide.
   [4]

The film production method according to any one of [1] to [3], wherein the platinum-containing material is supported on a carrier.

[5]

The film production method according to any one of [1] to [4], wherein the platinum-containing material has a volume-based cumulative 50% size of 500 nm or more.

[6]

The film production method according to any one of [1] to [5], wherein the pore size of the filter Y is equal to or smaller than 20 times the volume-based cumulative 50% size of the additive.

[7]

The film production method according to any one of [1] to [6], wherein the groups convertible to ion exchange groups are groups convertible to sulfonic acid functional groups.

[8]

The film production method according to [7], wherein the fluorinated polymer has at least one type of units selected from the group consisting of units based on a compound represented by the formula (2-3) and units based on a compound represented by the formula (2-4):

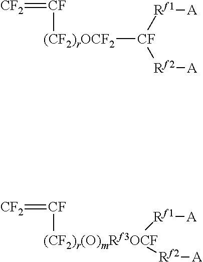

in the formulae (2-3) and (2-4), R^{f1} is a perfluoroalkylene group which may contain an oxygen atom between carbon atoms, R^{f2} is a single bond or a perfluoroalkylene group which may contain an oxygen atom between carbon atoms;
in the formula (2-4), R^{f3} is a single bond or a perfluoroalkylene group which may contain an oxygen atom between carbon atoms;
in the formulae (2-3) and (2-4), r is 0 or 1, and the two A are each independently a group convertible to a sulfonic acid functional group;
in the formula (2-4), m is 0 or 1.
   [9]

A polymer electrolyte membrane production method, which comprises producing a film by the film production method as defined in any one of [1] to [8],
obtaining a precursor membrane that is a laminate of the film and a woven fabric, and
converting the groups convertible to ion exchange groups in the precursor membrane to ion exchange groups to obtain a polymer electrolyte membrane.

### Advantageous Effects of Invention

According to an embodiment of the present invention, provided is a film production method by which it is possible to produce a film containing at least one type of additive selected from the group consisting of a platinum-containing material and cerium oxide, with suppressed formation of pinholes.

According to an embodiment of the present invention, also provided is a polymer electrolyte membrane production method.

### BRIEF DESCRIPTION OF DRAWINGS

FIG. 1 is a cross-sectional view schematically illustrating the electrolyte membrane with biased arrangement of the platinum-containing material.

FIG. 2 is a cross-sectional view schematically illustrating an example of the membrane electrode assembly of the present disclosure.

FIG. 3 is a cross-sectional view schematically illustrating an example of the membrane electrode assembly of the present disclosure.

### DESCRIPTION OF EMBODIMENTS

The following definitions of terms apply throughout the present specification and claims unless otherwise specified.

An “ion exchange group” refers to a group containing at least one ion exchangeable for a different ion, such as a sulfonic acid functional group and a carboxylic acid functional group as described below.

A “sulfonic acid functional group” refers to a sulfonic acid group (—SO₃H) or a sulfonate group. The sulfonate group may be, for example, (—SO₃⁻)Ma⁺, (—SO₃⁻)₂Mb²⁺ or (—SO₃⁻)₃Mc³⁺ (where Ma⁺ is an alkali metal ion or a quaternary ammonium cation; Mb²⁺ is a divalent metal ion; Mc³⁺ is a trivalent metal ion). When there are two ligands, the number of ion exchange groups is counted as 2, and when there are three ligands, the number of ion exchange groups is counted as 3.

A “carboxylic acid functional group” refers to a carboxylic acid group (—COOH) or a carboxylate group. The carboxylate group may be, for example, (—COO⁻)Ma⁺, (—COO⁻)₂Mb²⁺ or (—COO⁻)₃Mc³⁺ (where Ma⁺ is an alkali metal ion or a quaternary ammonium cation; Mb²⁺ is a divalent metal ion; and Mc³⁺ is a trivalent metal ion). When there are two ligands, the number of ion exchange groups is counted as 2, and when there are three ligands, the number of ion exchange groups is counted as 3.

A “precursor membrane” refers to a membrane containing a polymer having groups convertible to ion exchange groups.

A “group convertible to an ion exchange group” refers to a group that can be converted to an ion exchange group by treatments such as hydrolysis and conversion to acid form.

A “group convertible to a sulfonic acid functional group” refers to a group that can be converted to a sulfonic acid functional group by treatments such as hydrolysis and conversion to acid form.

A “group convertible to a carboxylic acid functional group” refers to a group that can be converted to a carboxylic acid functional group by treatments such as hydrolysis and conversion to acid form.

A “unit” in a polymer refers to an atomic group derived from a single monomer molecule, which is formed by polymerization reaction of the monomer. A unit may be an atomic group formed directly by polymerization or may be an atomic group formed by polymerization followed by modification to a partially different structure.

A numerical range expressed using “to” means a range including numerical values described before and after “to” as the lower and upper limits. In a series of numerical ranges described in the present specification, the upper limit or lower limit of a numerical range may be replaced by the upper limit or lower limit of another numerical range in the same series. The upper limit or lower limit of any numerical range described in the present specification may be replaced by any of numerical values indicated in Examples.

### [Film Production Method]

The film production method of the present disclosure is a film production method of conducting melt-extrusion using first pellets and second pellets to produce a film containing a fluorinated polymer and an additive.

The first pellets are prepared by melting a fluorinated polymer having units based on tetrafluoroethylene and having groups convertible to ion exchange groups and passing the melt through a filter X.

The second pellets are prepared by using the first pellets and at least one type of additive selected from the group consisting of a platinum-containing material and cerium oxide, and obtaining a melt containing the additive and the fluorinated polymer. Here, the second pellets are prepared by not passing the melt through a filter or by passing the melt through a filter Y having a pore size larger than 5 times the volume-based cumulative 50% particle size of the additive.

The mechanism as to why a film containing at least one type of additive selected from the group consisting of a platinum-containing material and cerium oxide, with suppressed formation of pinholes, can be produced by the film production method of the present disclosure (hereinafter also referred to simply as “the present production method”) is not clearly understood yet, however, the present inventors estimate as follows. In the following, “production of a film containing the additive, with suppressed formation of pinholes”, will also be referred to simply as “obtaining a film with suppressed formation of pinholes”.

For production of a film containing the additive, if a melt containing the additive is passed through a filter, the additive is removed by the filter and no film can be formed or the formed film contains no additive.

On the other hand, as a result of studies by the present inventors on a method of conducting extrusion without passing the melt through a filter to produce a film, the film may sometimes have pinholes.

Whereas in the present production method, in preparation of the first pellets, a melt of the fluorinated polymer is passed through the filter X. It is considered that foreign substances that may cause pinholes can be removed by the filter X.

Further, in the present production method, in preparation of the second pellets containing the additive, the melt is not passed through a filter, or is passed through the above predetermined filter Y. Then, in production of the second pellets, the second pellets can be prepared without removal of the additive by the filter. Further, it is considered that from the first pellets used for preparation of the second pellets, foreign substances that may cause pinholes are removed, and thus the second pellets also do not contain such foreign substances.

Thus, by conducting melt-extrusion using the first pellets and the second pellets, a film with suppressed formation of pinholes can be obtained.

Now, the step of melting the fluorinated polymer having units based on tetrafluoroethylene and having groups convertible to ion exchange groups, and passing the melt through the filter X to prepare the first pellets, will also be referred to as “first pellet preparation step”.

In the following, the step of using the first pellets and at least one type of additive selected from the group consisting of a platinum-containing material and cerium oxide, obtaining a melt containing the additive and the fluorinated polymer, and not passing the melt through a filter or passing the melt through the filter Y having a pore size larger than 5 times the volume-based cumulative 50% size of the additive, to prepare the second pellets containing the additive, will also be referred to as “second pellet preparation step”.

In the following, the step of conducting melt-extrusion using the first pellets and the second pellets to produce a film containing the fluorinated polymer and the additive, will also be referred to as “melt-extrusion step”.

That is, in the present production method, the first pellets are prepared in the first pellet preparation step, the second pellets are prepared using the first pellets in the second pellet preparation step, and a film is produced using the first pellets and the second pellets in the melt-extrusion step.

Now, the film production method of the present disclosure (the present production method) will be described in detail.

### <First Pellet Preparation Step>

In the first pellet preparation step, the first pellets are prepared by the following procedure.

First, the fluorinated polymer having units based on tetrafluoroethylene and having groups convertible to ion exchange groups (hereinafter also referred to as “fluorinated polymer (I′)”) is melted.

The melted fluorinated polymer (I′) is passed through the filter X.

Then, using the fluorinated polymer (I′) that has been passed through the filter X, the first pellets are prepared.

The fluorinated polymer (I′) is preferably a copolymer of a fluorinated monomer having a group convertible to a sulfonic acid functional group (hereinafter also referred to as “fluorinated monomer (S′)”) and tetrafluoroethylene (hereinafter this copolymer will also be referred to as “fluorinated polymer (S′)”).

The fluorinated polymer (S′) has units based on tetrafluoroethylene and units based on the fluorinated monomer (S′). That is, the fluorinated polymer (S′) has groups convertible to sulfonic acid functional groups.

Now, the fluorinated polymer (S′) will be described in detail.

Copolymerization for the fluorinated polymer (S′) may be conducted by a known method such as solution polymerization, suspension polymerization or emulsion polymerization.

The fluorinated monomer (S′) may be a compound having one or more fluorine atoms in its molecule, having an ethylenic double bond and having a group convertible to a sulfonic acid functional group.

The fluorinated monomer (S′) is preferably a compound represented by the formula (2), in view of the monomer production cost, the reactivity with other monomers and the ability to give the fluorinated polymer (S) with excellent properties.

CF₂═CF-L-(A)ₙ formula (2)

L is a (n+1)-valent perfluorohydrocarbon group which may contain an etheric oxygen atom.

The etheric oxygen atom may be located at a terminal end or may be located between carbon atoms of the perfluorohydrocarbon group.

The number of carbon atoms in the (n+1)-valent perfluorohydrocarbon group is preferably 1 or more, more preferably 2 or more, and preferably 20 or less, more preferably 10 or less.

As L, preferred is a (n+1)-valent perfluoroaliphatic hydrocarbon group which may contain an etheric oxygen atom. More preferred is a divalent perfluoroalkylene group which may contain an etheric oxygen atom as corresponding to an embodiment of n=1, or a trivalent perfluoroaliphatic hydrocarbon group which may contain an etheric oxygen atom as corresponding to an embodiment of n=2.

The above-mentioned divalent perfluoroalkylene group may be linear or branched.

A is a group convertible to a sulfonic acid functional group. As the group convertible to a sulfonic acid functional group, preferred is a functional group that can be converted to a sulfonic acid functional group by hydrolysis. Specific examples of the group convertible to a sulfonic acid functional group include —SO₂F, —SO₂Cl and —SO₂Br. When n=2, the two A may be the same or different.

The compound represented by the formula (2) is preferably a compound represented by the formula (2-1), a compound represented by the formula (2-2), a compound represented by the formula (2-3) or a compound represented by the formula (2-4).

CF₂═CF—O—R^{f1}-A formula (2-1)

CF₂═CF−R^{f1}-A formula (2-2)

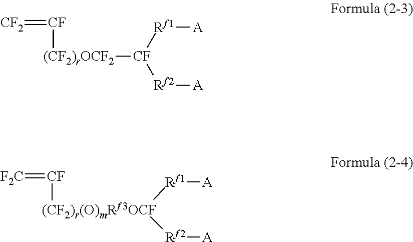

R^{f1} is a perfluoroalkylene group which may contain an oxygen atom between carbon atoms. The number of carbon atoms in the perfluoroalkylene group is preferably 1 or more, more preferably 2 or more, and is preferably 20 or less, more preferably 10 or less.

R^{f2} is a single bond or a perfluoroalkylene group which may contain an oxygen atom between carbon atoms. The number of carbon atoms in the perfluoroalkylene group is preferably 1 or more, more preferably 2 or more, and is preferably 20 or less, more preferably 10 or less.

R^{f3} is a single bond or a perfluoroalkylene group which may contain an oxygen atom between carbon atoms. The number of carbon atoms in the perfluoroalkylene group is preferably 1 or more, more preferably 2 or more, and is preferably 20 or less, more preferably 10 or less.

r is 0 or 1, and two A are each independently a group convertible to a sulfonic acid functional group.

m is 0 or 1.

The compound represented by the formula (2-1) and the compound represented by the formula (2-2) are preferably a compound represented by the formula (2-5).

CF₂═CF—(CF₂)ₓ—(OCF₂CFY)_{y}—O—(CF₂)_{z}—SO₃F formula (2-5):

x is 0 or 1, y is an integer of 0 to 2, z is an integer of 1 to 4, and Y is F or CF₃. When y=2, the two Y may be the same or different.

Specific examples of the compound represented by the formula (2-1) include the following compounds. In the formulae, w is an integer of 1 to 8, and x is an integer of 1 to 5.

CF₂═CF—O—(CF₂)_{w}—SO₂F

CF₂═CF—O—CF₂CF(CF₃)—O—(CF₂)_{w}—SO₂F

CF₂═CF—[O—CF₂CF(CF₃)]ₓ—SO₂F

Specific examples of the compound represented by the formula (2-2) include the following compounds. In the formulae, w is an integer of 1 to 8.

CF₂═CF—(CF₂)_{w}—SO₂F

CF₂═CF—CF₂—O—(CF₂)_{w}—SO₂F

As the compound represented by the formula (2-3), a compound represented by the formula (2-3-1) is preferred.

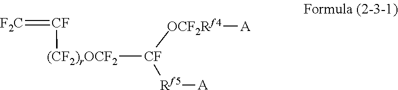

R^{f4} is a C₁₋₆ linear perfluoroalkylene group, and R^{f5} is a single bond or a C₁₋₆ linear perfluoroalkylene group which may contain an oxygen atom between carbon atoms.

r and A are as defined above.

Specific examples of the compound represented by the formula (2-3-1) are as follows.

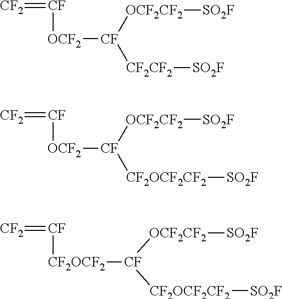

The compound represented by the formula (2-4) is preferably a compound represented by the formula (2-4-1).

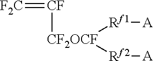

In the formula, R^{f1}, R^{f2} and A are as defined above.

Specific examples of the compound represented by the formula (2-4-1) are as follows.

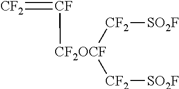

Single type of the fluorinated monomer (S′) may be used or two or more types may be used in combination.

For production of the fluorinated polymer (S′), in addition to tetrafluoroethylene and the fluorinated monomer (S′), other monomer may be used.

Specific examples of the other monomer include CF₂═CFR^{f6} (wherein R^{f6} is a C₂₋₁₀ perfluoroalkyl group), CF₂═CF—OR^{f7} (wherein R^{f7} is a C₁₋₁₀ perfluoroalkyl group), and CF₂═CFO(CF₂)ᵥCF═CF₂ (wherein v is an integer of 1 to 3).

The fluorinated polymer having the groups convertible to ion exchange groups in the fluorinated polymer (I′) converted to ion exchange groups, that is the after-described fluorinated polymer (I), has an ion exchange capacity of preferably 0.9 meq/g resin or more, and with a view to reducing the electrolysis voltage of an apparatus having the resulting ion exchange membrane incorporated therein, more preferably 1.0 meq/g resin or more, further preferably 1.1 meq/g resin or more, particularly preferably 1.25 meq/g resin or more. Further, the ion exchange capacity is preferably 2.00 meq/g resin or less, more preferably 1.90 meq/g resin or less, further preferably 1.40 meq/g resin or less, in that the resulting ion exchange membrane has more excellent strength.

The fluorinated polymer (I) to measure the ion exchange capacity is obtained as follows. First, the fluorinated polymer (I′) vacuum heat-treated at 240 °C under −0.1 MPaG for 16 hours, is immersed in a dimethyl sulfoxide/potassium hydroxide/water=30/5.5/64.5 (mass ratio) solution at 95 °C for 30 minutes to hydrolyze and convert the groups convertible to ion exchange groups in the fluorinated polymer (I′) to K form ion exchange groups, and the polymer is washed with water. Then, the polymer is immersed in an aqueous sodium hydroxide solution to convert the terminal end groups from K form to Na form to obtain the fluorinated polymer (I) for measurement of the ion exchange capacity.

The ion exchange capacity of the fluorinated polymer (1) thus obtained may be measured as described in Examples.

Single type of the fluorinated polymer (I′) may be used or two or more types may be used in combination.

In the first pellet preparation step, the molten fluorinated polymer (I′) is passed through the filter X.

The pore size of the filter X is, with a view to obtaining a film with further suppressed formation of pinholes, preferably 0.010 to 0.87 mm, more preferably 0.020 to 0.32 mm, particularly preferably 0.026 to 0.132 mm. In this specification, in a case where the filter X is a mesh filter, the pore size of the filter X refers to a mesh opening of the mesh filter.

The filter X is, with a view to obtaining a film with further suppressed formation of pinholes, preferably a mesh filter of 20 to 500 mesh, more preferably a mesh filter of 50 to 500 mesh, further preferably a mesh filter of 120 to 500 mesh. The “mesh” refers to the number of openings per inch (2.54 cm) in the mesh filter.

The pore size of the filter X is preferably 0.33 mm or less, more preferably 0.14 mm or less. The pore size of the filter X is 0.02 mm or more in many cases.

The material of the filter X is preferably a metal in view of heat resistance.

In the first pellet preparation step, the first pellets are prepared by using the fluorinated polymer (I′) that has been passed through the filter X.

Preparation of the first pellets may be conducted by a known method. For example, first, the fluorinated polymer (I′) that has been passed through the filter X is supplied to a known melt-extruder to obtain a melt of the fluorinated polymer (I′). The obtained melt of the fluorinated polymer (I′) is extruded from a nozzle of the melt-extruder and cooled to obtain a strand. The obtained strand is cut into a predetermined size to obtain the first pellets.

The melting temperature of the fluorinated polymer (I′) is not particularly limited and is preferably 150 to 350 °C, more preferably 200 to 300 °C.

Preparation of the first pellets may be conducted by a method other than the above method (so-called strand pelletizing), such as underwater pelletizing or hot face cutting.

The filter X may be installed in the vicinity of the nozzle of the melt-extruder. That is, the procedure of passing the molten fluorinated polymer (I′) through the filter X may be conducted by the melt-extruder.

The shape of the first pellets is not particularly limited and may be, for example, spherical (including ellipsoidal) and columnar (for example cylindrical).

The size of the first pellets obtained by the first pellet preparation step is not particularly limited and for example, in a case where the first pellets are cylindrical, it is preferred that their diameter is 2 to 3 mm and length is 2 to 3 mm.

The first pellets obtained by the first pellet preparation step preferably have a plurality of grooves formed on their surface. By the grooves, adhesion of the first pellets can be suppressed.

The grooves on the surface of the first pellets may be formed on the entire surface of the first pellets, however, they are usually formed preferably only on side surfaces of the pellets (surfaces other than the cut surfaces of the strand).

The grooves on the surface of the first pellets are formed preferably mainly along the direction intersecting with the first pellet cur surface (strand machine direction).

In the first pellet preparation step, after the strand is cut, roughening treatment of roughening the surface of the first pellets may be conducted. By this treatment, the surface of the first pellets is further roughened to further suppress adhesion of the first pellets.

The roughening treatment may be specifically, for example, conducted by stirring the first pellets by a mixing machine (for example a V blender).

The light transmittance of the first pellets is preferably 30 to 60%, more preferably 30 to 50%, further preferably 30 to 40%. The first pellets having the light transmittance within the above range are estimated to have roughened surface, and thus considered to be such that the contact area between the first pellets is small and adhesion between the first pellets is suppressed. Thus, a pressure variation at the time of forming the film in the after-described melt-extrusion step is suppressed, and a film more excellent in uniformity of the membrane thickness can be obtained.

The light transmittance of the first pellets refers to a visible light transmittance (measurement wavelength 400 to 700 nm) measured by using a luminous transmissometer (manufactured by Asahi Spectra Co., Ltd., MODEL 304 or equivalent apparatus), and the specific measurement method is as follows.

The luminous transmissometer is adjusted so that the visible light transmittance will be 100% without the above-described sample holder placed on a sample table. Then, a sample holder having a hole with a predetermined size (for example a rectangular hole of 2 to 3 mm×2 to 3 mm) into which a pellet is to be inserted, is placed on the sample table, and the light intensity is adjusted so that the visible light transmittance without a pellet inserted into the hole of the sample holder will be 25%.

Then, a first pellet of the same size as the hole of the sample holder is inserted into the hole of the sample holder, and the visible light transmittance is measured. Measurement of the visible light transmittance of the first pellet is conducted on several positions for one pellet, and the arithmetic mean is obtained. For example, in a case where the first pellet is cylindrical, the first pellet is inserted into the hole of the sample holder so that the side surface of the first pellet is irradiated with light, the first pellet is rotated by 90 degrees at a time in the circumferential direction to measure the visible light transmittance at three positions on one pellet, and the arithmetic mean is obtained.

And, the visible light transmittance of the first pellet is calculated, based on the visible light transmittance (25%) before the first pellet is inserted into the hole of the sample holder being 100% (that is, the measured visible light transmittance of the first pellet is multiplied by 4), and is taken as the light transmittance (%) of the first pellets.

### <Second Pellet Preparation Step>

In the second pellet preparation step, the second pellets are prepared by the following procedure Y1 or the procedure Y2.

In the procedure Y1 and the procedure Y2, using the first pellets and at least one type of additive selected from the group consisting of a platinum-containing material and cerium oxide, a melt containing the additive and the fluorinated polymer (fluorinated polymer (I′)) is obtained.

Then, in the procedure Y1, the second pellets are prepared by using the obtained melt.

On the other hand, in the procedure Y2, the obtained melt is passed through the filter Y described later, and then the second pellets are prepared.

First, the procedure Y1 will be described.

In the procedure Y1, first, using the first pellets and at least one type of additive selected from the group consisting of a platinum-containing material and cerium oxide, a melt containing the additive and the fluorinated polymer is obtained.

The additive may be only the platinum-containing material, may be only the cerium oxide or may be both the platinum-containing material and the cerium oxide.

The platinum-containing material contains a platinum atom. Specific examples of the platinum-containing material include elemental platinum, platinum oxide, a composite metal oxide containing platinum and a platinum alloy.

The composite oxide containing platinum may be, for example, MₓPt₃O₄ (M is at least one metal atom selected from the group consisting of Li, Na, Mg, Ca, Zn, Cd, Co, Ni, Mn, Cu, Ag, Bi and Ce, and x is more than 0 and 1 or less).

The metal alloy may be, for example, an alloy containing platinum and at least one metal selected from the group consisting of transition metals and noble metals other than platinum).

The platinum-containing material may be, for example, in particulate form or sheet form. In a case where the platinum-containing material is in particulate form, the platinum-containing material may be in the form of core/shell particles. An example of the core/shell particles includes an embodiment in which the core is constituted by carbon or is a particle containing a metal other than platinum, and the shell contains a platinum atom.

The platinum-containing material may be supported on a carrier. The carrier may be, for example, a carbon carrier such as a carbon black power, graphitized carbon, carbon fiber or carbon nanotube. However, in view of heat resistance in a high temperature environment e.g. at the time of melt-extrusion, it is preferred that no carbon carrier is contained.

In a case where the platinum-containing material is supported on a carrier, the amount of the platinum-containing material supported is, to the total mass of the platinum-containing material and the carrier, preferably 10 mass % or more, more preferably 20 mass % or more, further preferably 30 mass % or more, and preferably 50 mass % or less.

In a case where the platinum-containing material is in particulate form, the average particle size (D50 described below) of the platinum-containing material is preferably 1 nm or more, more preferably 5 nm or more, further preferably 10 nm or more, particularly preferably 100 nm or more, and may be 500 nm or more. Further, the average particle size (D50 described below) of the platinum-containing material is preferably 50 μm or less, more preferably 30 μm or less, further preferably 14 μm or less, particularly preferably 7 μm or less.

The average particle size of the platinum-containing material is the volume-based cumulative 50% particle size (D50) obtained from the particle size distribution measured by the following method.

The average particle size of the platinum-containing material is obtained by measuring particle sizes of 40000 particles in dry manner using image analysis particle size distribution measuring apparatus (for example manufactured by Malvern Panalytical, Morphologi (registered trademark) series), and determining the cumulative 50% size (D50) in a volume-based particle size distribution cumulative curve. In a case where particles of less than 500 nm are contained, equivalent circle diameters of 100 particles are measured by a SEM (scanning electron microscope) and the cumulative 50% size (D50) of a volume-based particle size distribution curve is obtained.

The platinum-containing material may be constituted by monodispersed primary particles or may be constituted by secondary particles having a plurality of primary particles agglomerated. In a case where the platinum-containing material contains secondary particles, to obtain the D50, particle sizes of the secondary particles are measured.

The cerium oxide may be CeO₂ (cerium(IV) oxide) or may be Ce₂O₃ (cerium(III) oxide), and in view of stability, it is preferably CeO₂.

The cerium oxide may be doped with a polyvalent metal ion of e.g. zirconium or praseodymium.

The cerium oxide is preferably in particulate form.

In a case where the cerium oxide is in particulate form, the average particle size (D50 described below) of the cerium oxide is preferably 10 nm or more, more preferably 100 nm or more, further preferably 1 μm or more, particularly preferably 3 μm or more, and is preferably 30 μm or less, more preferably 14 μm or less, further preferably 10 μm or less.

When the average particle size of the cerium oxide is 10 nm or more, agglomeration of the cerium oxide is suppressed, and the cerium oxide may readily be formed into a stable dispersed state. When the average particle size of the cerium oxide is 30 μm or less, the chemical durability of an ion exchange membrane formed from the resulting film will further be improved.

The method of measuring the average particle size of the cerium oxide is the same as the method for measuring the average particle size (D50) of the platinum-containing material.

As a method of obtaining the melt containing the additive and the fluorinated polymer (I′), for example, a method may be mentioned in which the first pellets and the additive are mixed and kneaded with heating, and further heated to melt.

A means for the above method is not particularly limited, and for example, kneading by a mixer and a twin screw extruder may be mentioned.

In the melt, the content of the additive is preferably 0.1 to 20 mass %, more preferably 0.1 to 10 mass % to the total mass of the melt.

In the procedure Y1, the obtained melt is used to prepare the second pellets.

On that occasion, the melt is used to prepare the second pellets without being passed through a filter.

The method for preparing the second pellets in the procedure Y1 is the same as the method for preparing the first pellets except that the melt is not passed through a filter, and the description is omitted.

In the procedure Y2, the obtained melt is passed through the filter Y.

The filter Y has a pore size larger than 5 times the volume-based cumulative 50% particle size (D50) of the additive. The method of measuring D50 of the additive is as described above.

The pore size of the filter Y is not particularly limited so long as it is larger than 5 times D50 of the additive, and is preferably equal to or larger than 10 times. The pore size of the filter Y is in many cases equal to or smaller than 1000 times D50 of the additive, and is preferably equal to or smaller than 100 times, more preferably equal to or smaller than 50 times, further preferably equal to or smaller than 20 times, in that foreign substances which may be included in the second pellet preparation step are removed, whereby a film with further suppressed formation of pinholes can be obtained.

Particularly in a case where the platinum-containing material having D50 of 500 nm or more, further 5 μm or more, is contained, the pore size of the filter Y is preferably equal to or smaller than 20 times, more preferably equal to or smaller than 15 times, in that a film with further suppressed formation of pinholes is obtained.

In a case where two or more types of the additives are contained, the pore size of the filter Y is larger than 5 times D50 of the additive with the largest D50. Further, in a case where two or more types of the additives are contained, the pore size of the filter Y is preferably within the above preferred range with respect to D50 of the additive with the largest D50.

In this specification, in a case where the filter Y is a mesh filter, the pore size of the filter Y refers to the mesh opening of the mesh filter.

The filter Y is, in that foreign substances which may be included in the second pellet preparation step are removed, whereby a film with further suppressed formation of pinholes can be obtained, preferably a mesh filter of 20 to 300 mesh, more preferably a mesh filter of 50 to 200 mesh, further preferably a mesh filter of 100 to 200 mesh. The “mesh” refers to the number of openings per inch (2.54 cm) in the mesh filter.

The pore size of the filter Y is preferably 1.00 mm or less, more preferably 0.33 mm or less, further preferably 0.30 mm or less, particularly preferably 0.16 mm or less. The pore size of the filter Y is preferably 0.07 mm or more.

The material of the filter Y is preferably a metal in view of heat resistance.

In the procedure Y2, the obtained melt is passed through the filter Y, and then the second pellets are prepared. The method for preparing the second pellets is the same as the method for preparing the first pellets and the description is omitted. In the procedure Y2, the filter Y may be installed in the vicinity of the nozzle of the melt-extruder. That is, the procedure of passing the melt through the filter Y may be conducted by the melt-extruder.

Preferred embodiments of the second pellets obtained in the second pellet preparation step are the same as those of the first pellets except for the transmittance, and their description is omitted.

### <Melt-Extrusion Step>

In the melt-extrusion step, melt-extrusion is conducted by using the first pellets and the second pellets to obtain a film. The obtained film contains the fluorinated polymer (I′) and the additive.

The melt-extrusion step is not particularly limited so long as a film is obtained by melt-extrusion. As an example of the melt-extrusion step, a method may be mentioned in which the first pellets and the second pellets are kneaded to obtain a melt of a mixture of the first pellets and the second pellets, and the melt of the mixture is extruded from a die while being cooled and formed into a film.

As a method of preparing the melt of the mixture of the first pellets and the second pellets, the same method as the method of obtaining the melt in the second pellet preparation step may be mentioned. When the melt of the mixture is obtained by a twin screw extruder, the obtained melt of the mixture may be continuously supplied to a die and formed into a film.

The amount of the second pellets supplied in the melt-extrusion step may be properly adjusted in accordance with the content of the additive in the second pellets and the desired content of the additive in the film. For example, the amount of the second pellets supplied in the melt-extrusion step is preferably 1.0 to 50.0 mass %, more preferably 3.3 to 20.0 mass % to the total amount of the first pellets and the second pellets supplied.

Further, in the melt-extrusion step, a film having the layer obtained from the first pellets and the second pellets, and other layer, laminated, may be obtained.

That is, the melt-extrusion step may be a co-extrusion step.

The above other layer may be a layer obtained from the first pellets. The above other layer may also be a layer obtained from a melt of a mixture in which the amount of the second pellets is different from that in the above-described melt of the mixture. Further, the above other layer may be a layer obtained from a melt of a mixture in which the type of the additive contained in the second pellets is different from that in the above-described melt of the mixture.

In the melt-extrusion step, it is possible to use the first pellets, the second pellets containing only the platinum-containing material (hereinafter also referred to as “second pellets A” for convenience) and the second pellets containing only the cerium oxide (hereinafter also referred to as “second pellets B” for convenience).

That is, two or more types of the second pellets may be used, and at least one is the second pellets A containing only the platinum-containing material and at least one is the second pellets B containing only the cerium oxide.

A film obtained by the melt-extrusion step according to the above embodiment contains the fluorinated polymer (I′), the platinum-containing material and the cerium oxide.

The membrane thickness of the obtained film may properly be adjusted and may be, for example, 0.5 to 500 μm. Particularly, the membrane thickness of the obtained film is preferably 10 μm or more, more preferably 20 μm or more, and may be 30 μm or more. The membrane thickness of the obtained film is preferably 400 μm or less, more preferably 300 μm or less, and may be 200 μm or less, may be 90 μm or less, and may be 60 μm or less.

In a case where the obtained film has a multilayer structure, the membrane thickness refers to the total membrane thickness.

In a case where the obtained film has a single layer structure and contains the platinum-containing material, the mass ratio of the platinum-containing material to the fluorinated polymer (I′) (the mass of the platinum-containing material/the mass of the fluorinated polymer (I′)) in the film is preferably 0.0005 or more, more preferably 0.004 or more, further preferably 0.007 or more, and is preferably 0.024 or less, preferably 0.014 or less. When the mass ratio is 0.0005 or more, the occurrence of hydrogen crossover can be further suppressed when a polymer electrolyte membrane formed by using the film is applied to a water electrolyzer. When the mass ratio is 0.024 or less, the electrolysis voltage can be further decreased when a polymer electrolyte membrane formed by using the film is applied to a water electrolyzer.

In a case where the obtained film contains the platinum-containing material and the platinum-containing material is supported on a carrier, the mass ratio of the carrier supporting the platinum-containing material to the fluorinated polymer (I′) (the mass of the fluorinated polymer (I′)/the mass of the carrier) is preferably 10.0 or more, more preferably 30.0 or more, further preferably 60.0 or more, and is preferably 500 or less.

The above ratios may be adjusted by the amount of the first pellets and the second pellets supplied.

In a case where the obtained film contains the platinum-containing material, the mass of the platinum-containing material per 1 cm² of the film is preferably 0.005 mg/cm² or more, more preferably 0.010 mg/cm² or more, further preferably 0.015 mg/cm² or more, and is preferably 0.050 mg/cm² or less, more preferably 0.040 mg/cm² or less.

When the mass of the platinum-containing material is 0.005 mg/cm² or more, the occurrence of hydrogen crossover can be further suppressed when a polymer electrolyte membrane formed by using the film is applied to a water electrolyzer. When the mass of the platinum-containing material is 0.050 mg/cm² or less, the electrolysis voltage can further be reduced when a polymer electrolyte membrane formed by using the film is applied to a water electrolyzer.

In a case where the obtained film contains the cerium oxide, the mass of the cerium oxide per 1 cm² of the film is preferably 0.005 mg/cm² or more, more preferably 0.010 mg/cm² or more, further preferably 0.015 mg/cm² or more, particularly preferably 0.020 mg/cm² or more, most preferably 0.030 mg/cm² or more, and is preferably 0.300 mg/cm² or less, more preferably 0.150 mg/cm² or less, further preferably 0.100 mg/cm² or less.

In a case where the mass of the cerium oxide is 0.005 mg/cm² or more, the film tends to be whitish, and foreign substances present in the film are likely to be visible. Thus, when a polymer electrolyte membrane formed by using the film is applied to a water electrolyzer, a portion where the foreign substances are present in the electrolyte membrane can be avoided, and formation of pinholes in the electrolyte membrane, derived from the foreign substances, can be suppressed.

When the mass of the cerium oxide is 0.300 mg/cm² or less, the electrolysis voltage can be further decreased.

The film obtained by the present production method has suppressed formation of pinholes as described above.

The film obtained by the present production method is suitable for production of a polymer electrolyte membrane as described below.

### [Polymer Electrolyte Membrane Production Method]

The polymer electrolyte membrane production method of the present disclosure is a method of obtaining a precursor membrane by stacking the film obtained by the present production method and a woven fabric, and converting the groups convertible to ion exchange groups in the precursor membrane to ion exchange groups to obtain a polymer electrolyte membrane.

Now, the polymer electrolyte membrane production method of the present disclosure (hereinafter the polymer electrolyte membrane will also be referred to simply as “electrolyte membrane”, and the polymer electrolyte membrane production method of the present disclosure will also be referred to simply as “the present electrolyte membrane production method”).

In the present electrolyte membrane production method, a precursor membrane having the film obtained by the present production method and a woven fabric stacked is obtained.

As a specific method of obtaining the precursor membrane, a method of arranging the film, a woven fabric and the film in this order and hot-pressing the members to obtain the precursor membrane may be mentioned.

The hot pressing method is not particularly limited and may be, for example, flat pressing, roll pressing or vacuum pressing.

To obtain the precursor membrane, one or more of the films obtained by the present production method may be used. In the above embodiment, two films obtained by the present production method are used, however, for example, one of the two films may be replaced with other film formed by using the first pellets. As the film obtained by the present production method, the film containing only the platinum-containing material as the additive and the film containing only the cerium oxide as the additive may be used. Further, the other film formed by using the first pellets, a woven fabric, the other film formed by using the first pellets and the film obtained by the present production method may be arranged in this order to obtain the precursor membrane.

The distribution of the additive in the obtained electrolyte membrane may be adjusted by controlling the thicknesses, the order of stacking, the number of films stacked, etc. of the film obtained by the present production method and the other film formed by using the first pellets.

The precursor membrane is obtained in such a manner that the woven fabric is embedded in the matrix derived from the film containing the fluorinated polymer (I′) and the additive.

Now, the woven fabric used in the present electrolyte membrane production method will be described and then the method of converting the groups convertible to ion exchange groups to ion exchange groups will be described.

The woven fabric functions to improve the dimensional stability, strength, handleability etc. of the resulting electrolyte membrane.

The aperture ratio of the woven fabric is preferably 50% or higher, more preferably 55% or higher, further preferably 60% or higher, particularly preferably 70% or higher, with a view to achieving a lower electrolysis voltage when applied to a water electrolyzer.

The upper limit of the aperture ratio of the woven fabric is preferably 90% or lower, more preferably 80% or lower, with a view to achieving higher strength of the membrane electrode assembly to be formed by using the electrolyte membrane.

The aperture ratio of the woven fabric is calculated by the following formula (E) based on the average diameter R1 of yarns constituting the woven fabric and the average spacing P1 (hereinafter also referred to as “pitch P1”) between adjacent ones of yarns constituting the woven fabric.

Here, the average diameter R1 of yarns is an arithmetic mean of diameter measurements of 10 different yarns arbitrarily selected on a magnified image of the woven fabric surface (e.g. at a magnification of 100) taken by a microscope. Further, the pitch P1 is an arithmetic mean of measurements of 10 different spacings arbitrarily selected on a magnified image of the woven fabric surface (e.g. at a magnification of 100) taken by a microscope.

Aperture ratio (%) of woven fabric=[P1/(P1+R1)]²×100 (ε)

The denier count of yarns constituting the woven fabric is preferably 2 or more. With a view to achieving higher strength and dimensional stability of the membrane electrode assembly formed by using the electrolyte membrane, the denier count is more preferably 10 or more, particularly preferably 15 or more.

The upper limit of the denier count of yarns constituting the woven fabric is preferably 60 or less, more preferably 50 or less, particularly preferably 20 or less, with a view to achieving a lower electrolysis voltage when applied to a water electrolyzer.

Here, the denier count refers to a value that expresses the mass of 9000 m of yarns in grams (g/9000 m).

With a view to achieving high strength and dimensional stability of the membrane electrode assembly formed by using the electrolyte membrane, the density of yarns constituting the woven fabric is preferably 50 yarns/inch or more, more preferably 70 yarns/inch or more, particularly preferably 90 yarns/inch or more. With a view to achieving a lower electrolysis voltage when applied to a water electrolyzer, the density of yarns constituting the woven fabric is preferably 200 yarns/inch or less, more preferably 150 yarns/inch or less, particularly preferably 100 yarns/inch or less.

The yarns constituting the woven fabric can be each composed of either a monofilament consisting of one filament or a multifilament consisting of two or more filaments. Preferred is a monofilament.

The yarns constituting the woven fabric are each independently preferably made of a material selected from the group consisting of a polytetrafluoroethylene (hereinafter also referred to as “PTFE”), a tetrafluoroethylene/perfluoroalkyl vinyl ether copolymer (hereinafter also referred to as “PFA”), a polyether ether ketone (hereinafter also referred to as “PEEK”) and a polyphenylene sulfide (hereinafter also referred to as “PPS”) to achieve higher durability of the yarns.

The yarns constituting the woven fabric are preferably in the form of slit yarns to achieve higher durability and strength of the yarns.

In the case where the material constituting the woven fabric is PTFE, in view of good balance between strength and handleability of the resulting electrolyte membrane, the fabric weight of the woven fabric is preferably 20 g/m² or more, more preferably 30 g/m² or more, and is preferably 40 g/m² or less.

In the case where the material constituting the woven fabric is PFA, in view of good balance between strength and handleability of the resulting electrolyte membrane, the fabric weight of the woven fabric is preferably 10 g/m² or more, and is preferably 30 g/m² or less, more preferably 20 g/m² or less.

In the case where the material constituting the woven fabric is PEEK, in view of good balance between strength and handleability of the resulting electrolyte membrane, the fabric weight of the woven fabric is preferably 5 g/m² or more, and is preferably 40 g/m² or less, more preferably 30 g/m² or less.

In the case where the material constituting the woven fabric is PPS, in view of good balance between strength and handleability of the resulting electrolyte membrane, the fabric weight of the woven fabric is preferably 5 g/m² or more, and is preferably 40 g/m² or more, more preferably 30 g/m² or less.

The content of the woven fabric to the total mass of the resulting electrolyte membrane is preferably 3 mass % or more, more preferably 5 mass % or more, and is preferably 50 mass % or less, more preferably 40 mass % or less, further preferably 30 mass % or less.

The conversion of the groups convertible to ion exchange groups in the precursor membrane to ion exchange groups may be carried out by, for example, subjecting the precursor membrane to treatment such as hydrolysis and conversion to acid form.

In particular, preferred is contact treatment of the precursor membrane with an aqueous alkaline solution.

The contact treatment of the precursor membrane with the aqueous alkaline solution may be performed by, for example, immersion of the precursor membrane in the aqueous alkaline solution, spraying of the aqueous alkaline solution onto the surface of the precursor membrane, or the like.

The temperature of the aqueous alkaline solution is preferably 30 °C or higher, more preferably 40 °C or higher, and is preferably 100 °C or lower. The contact time of the precursor membrane and the aqueous alkaline solution is preferably 3 minutes or more, more preferably 5 minutes or more, and is preferably 150 minutes or less, more preferably 50 minutes or less.

The aqueous alkaline solution preferably contains an alkali metal hydroxide, a water-soluble organic solvent and water.

The alkali metal hydroxide may be sodium hydroxide or potassium hydroxide.

In this specification, the water-soluble organic solvent refers to an organic solvent easily soluble in water. Specifically, preferred is an organic solvent with a solubility of 0.1 g or more in 1000 ml of water (20 °C), and an organic solvent with a solubility of 0.5 g or more is particularly preferred. The water-soluble organic solvent preferably contains at least one kind selected from the group consisting of aprotic organic solvents, alcohols and amino alcohols, and more preferably contains an aprotic organic solvent.

Single type of the water-soluble organic solvent may be used or two or more types may be used in combination.

Specific examples of the aprotic organic solvents include dimethyl sulfoxide, N,N-dimethylformamide, N,N-dimethylacetamide, N-methyl-2-pyrrolidone and N-ethyl-2-pyrrolidone. Preferred is dimethyl sulfoxide.

Specific examples of the alcohols include methanol, ethanol, isopropanol, butanol, methoxyethoxyethanol, butoxyethanol, butylcarbitol, hexyloxyethanol, octanol, 1-methoxy-2-propanol and ethylene glycol.

Specific examples of the amino alcohols include ethanolamine, N-methyl ethanolamine, N-ethyl ethanolamine, 1-amino-2-propanol, 1-amino-3-propanol, 2-aminoethoxyethanol, 2-aminothioethoxyethanol and 2-amino-2-methyl-1-propanol.

The concentration of the alkali metal hydroxide in the aqueous alkaline solution is preferably 1 mass % or more, more preferably 3 mass % or more, and is preferably 60 mass % or less, more preferably 55 mass % or less.

The content of the water-soluble organic solvent in the aqueous alkaline solution is preferably 1 mass % or more, more preferably 3 mass % or more, and is preferably 60 mass % or less, more preferably 55 mass % or less.

The concentration of water in the aqueous alkaline solution is preferably 39 to 80 mass %.

After the contact treatment of the precursor membrane with the aqueous alkaline solution, any treatment for removing the aqueous alkaline solution may be performed. The aqueous alkaline solution may be removed by, for example, washing, with water, the precursor membrane contact-treated with the aqueous alkaline solution.

After the contact treatment of the precursor membrane with the aqueous alkaline solution, the thus-obtained membrane may be further treated by contact with an aqueous acidic solution to convert the ion exchange groups to acid form.

The contact treatment of the precursor membrane with the aqueous acidic solution may be performed by, for example, immersion of the precursor membrane in the aqueous acidic solution or spraying of the aqueous acidic solution onto the surface of the precursor membrane.

The aqueous acidic solution preferably contains an acid component and water.

Specific examples of the acid component include hydrochloric acid and sulfuric acid.

By converting the groups convertible to ion exchange groups in the precursor membrane to ion exchange groups, an electrolyte membrane containing the fluorinated polymer having ion exchange groups (hereinafter also referred to as “the fluorinated polymer (I)”) is obtained.

The fluorinated polymer (I) is a fluorinated polymer obtained by converting the groups convertible to ion exchange groups of the fluorinated polymer (I′) in the precursor membrane to ion exchange groups.

Now, the fluorinated polymer obtained by converting the groups convertible to sulfonic acid functional groups of the fluorinated polymer (S′) to sulfonic acid functional groups (hereinafter also referred to as “fluorinated polymer (S)”) will be described.

The fluorinated polymer (S) is preferably obtained by converting the groups convertible to sulfonic acid functional groups in the above fluorinated polymer (S′) to sulfonic acid functional groups.

The fluorinated polymer (S) preferably has units based on tetrafluoroethylene and units based on a monomer having a sulfonic acid functional group and a fluorine atom.

The units based on a monomer having a sulfonic acid functional group and a fluorine atom are preferably units represented by the formula (2S).

—[CF₂—CF(-L-(SO₃M^{S})ₙ)]- formula (2S):

In the formula (2S), L and n are as defined for the above formula (2).

M^{S} is a hydrogen atom, an alkali metal or a quaternary ammonium cation. When n=2, the two M^{S} may be the same or different.

The units represented by the formula (2S) are preferably units represented by the formula (2S-1), units represented by the formula (2S-2), units represented by the formula (2S-3) or units represented by the formula (2S-4).

—[CF₂—CF(—O—R^{f1}—SO₃M^{S})]- formula (2S-1)

—[CF₂—CF(—R^{f1}—SO₃M^{S})]- formula (2S-2)

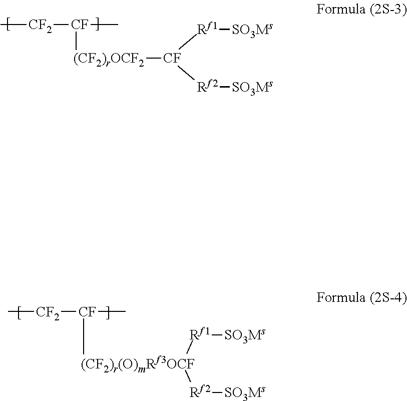

In the formulae (2S-1) to (2S-4), R^{f1}, R^{f2}, R^{f3}, r and m are as defined for the above formulae (2-1) to (2-4).

M^{S} is as defined above.

Specific examples of the units represented by the formula (2S-1) include the following units. In the formulae, w is an integer of 1 to 8, and x is an integer of 1 to 5. In the formulae, M^{S} is as defined above.

—[CF₂—CF(—O—(CF₂)_{w}—SO₃M^{S})]-

—[CF₂—CF(—O—CF₂CF(CF₃)—O—(CF₂)_{w}—SO₃M^{S})]-

—[CF₂—CF(—(O—CF₂CF(CF₃))ₓ—SO₃M^{S})]-

Specific examples of the units represented by the formula (2S-2) include the following units. In the formulae, w is an integer of 1 to 8. In the formulae, M^{S} is as defined above.

—[CF₂—CF(—(CF₂)_{w}—SO₃M^{S})]-

—[CF₂—CF(—CF₂—O—(CF₂)_{w}—SO₃M^{S})]-

The units represented by the formula (2S-3) are preferably units represented by the formula (2S-3-1). In the formula, M^{S} is as defined above.

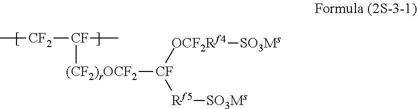

In the formula (2S-3-1), R^{f4}, R^{f5} and r are as defined for the above formula (2-3-1). M^{S} is as defined above.

Specific examples of the units represented by the formula (2S-3) are as follows.

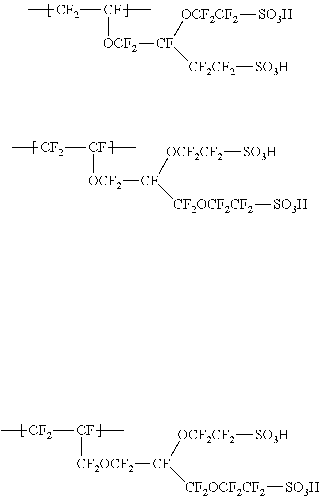

The units represented by the formula (2S-4) are preferably units represented by the formula (2S-4-1). In the formula, R^{f1}, R^{f2} and M^{S} are as defined above.

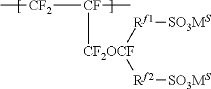

Specific examples of the units represented by the formula (2S-4-1) are as follows.

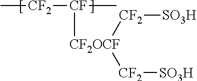

Single type of the units having a sulfonic acid functional group and a fluorine atom may be contained, or two or more types may be contained.

The fluorinated polymer (S) may have units based on other monomer, other than the units based on tetrafluoroethylene and the units based on a monomer having a sulfonic acid functional group and a fluorine atom.

Specific examples of the other monomer are as exemplified above. The content of the units based on the other monomer is preferably 30 mass % or less to all units in the fluorinated polymer (S) with a view to maintaining the ion exchange performance.

The electrolyte membrane may have a single-layer structure or a multilayer structure. Specific embodiments of the electrolyte membrane having a multilayer structure include those having a laminated structure of electrolyte layers different in content of at least one of the platinum-containing material and the cerium oxide, and having a laminated structure of electrolyte layers different in ion exchange capacity.

Each of the platinum-containing material and the cerium oxide contained in the electrolyte membrane may be distributed throughout the entire electrolyte membrane or may be arranged biased to one side of the electrolyte membrane.

It is preferred that at least one of the platinum-containing material and the cerium oxide is arranged biased to one side of the electrolyte membrane. It is more preferred that, among the platinum-containing material and the cerium oxide, at least the platinum-containing material is arranged biased to one side of the electrolyte membrane. The platinum-containing material and the cerium oxide (that is, both of the platinum-containing material and the cerium oxide) may be arranged biased to one side of the electrolyte membrane.

In the case where the electrolyte membrane is applied to a water electrolyzer, the side of the electrolyte membrane to which the platinum-containing material is arranged biased is preferably located on the anode side with a view to further suppressing hydrogen crossover. In such a case, the catalyst contained in the catalyst layer in the anode preferably contains iridium oxide, whereby the above effects will be more excellent.

In the present specification, the expression “the platinum-containing material is arranged biased to one side of the electrolyte membrane” means that the concentration of the platinum-containing material in a region extending from one surface (hereinafter also referred to “surface A”) of the electrolyte membrane to a predetermined depth position (hereinafter also referred to as “depth position B”) before reaching the other surface (hereinafter also referred to as “surface C”) of the electrolyte membrane is higher than the concentration of the platinum-containing material in a region extending from the surface C to the depth position B.

Further, the expression “the cerium oxide is arranged biased to one side of the electrolyte membrane” means that the concentration of the cerium oxide in a region from the surface A to a depth position B is higher than the concentration of the cerium oxide in a region from the surface C to the depth position B.

Furthermore, the expression “the platinum-containing material and the cerium oxide are arranged biased to one side of the electrolyte membrane” means that the concentration of the platinum-containing material in a region from the surface A to a depth position B is higher than the concentration of the platinum-containing material in a region from the surface C to the depth position B and, at the same time, the concentration of the cerium oxide in the region from the surface A to the depth position B is higher than the concentration of the cerium oxide in the region from the surface C to the depth position B.

As a preferable embodiment of the electrolyte membrane in which the platinum-containing material is arranged biased to one side of the electrolyte membrane, an embodiment may be mentioned in which the concentration of the platinum-containing material in a region from the surface A to a depth position B₅₀ corresponding to 50% of the membrane thickness of the electrolyte membrane is higher than the concentration of the platinum-containing material in a region from the surface C to the depth position B₅₀.

The state in which “the platinum-containing material is arranged biased to one side of the electrolyte membrane” will be described in detail below with reference to FIG. 1. FIG. 1 is a cross-sectional view schematically illustrating the electrolyte membrane with biased arrangement of the platinum-containing material.

In FIG. 1, an electrolyte membrane 1 has a surface A1 as one surface and a surface C1 as the other surface. A depth position B1 represents a position at a distance T_{X} away from the surface A1 toward the surface C1.

The minimum distance T₁ from the surface A1 to the surface C1 of the electrolyte membrane 1 corresponds to the membrane thickness of the electrolyte membrane 1. The distance T_{X} is X % of the distance T₁. For example, in the case where the distance T_{X} is 20% of the distance T₁, the depth position B1 is a position corresponding to 20% of the membrane thickness (distance T₁) of the electrolyte membrane 1 from the surface A1 of the electrolyte membrane 1.

A region X represents a region from the surface A1 to the depth position B1, and a region Y represents a region from the surface C1 to the depth position B1.

In the case where there are convex-concave parts on the surface of the electrolyte membrane 1, the above distances are measured with respect to the position at which the membrane thickness of the electrolyte membrane 1 becomes minimum.

In FIG. 1, when the concentration of the platinum-containing material in the region X is higher than the concentration of the platinum-containing material in the region Y, it can be said that the platinum-containing material is arranged biased to one side of the electrolyte membrane.

With a view to obtaining more excellent effects of the present disclosure, the platinum-containing material contained in the electrolyte membrane is preferably present in a region from one surface of the electrolyte membrane to a position of 25% of the membrane thickness of the electrolyte membrane, more preferably present in a region from one surface of the electrolyte membrane to a position of 20% of the membrane thickness of the electrolyte membrane, further preferably present in a region from one surface of the electrolyte membrane to a position of 15% of the membrane thickness of the electrolyte membrane, still more preferably present in a region from one surface of the electrolyte membrane to a position of 10% of the membrane thickness of the electrolyte membrane. Further, it is more preferred that the platinum-containing material contained in the electrolyte membrane is present only in a region up to the above membrane thickness position.

The locations of presence of the platinum-containing material and the cerium oxide in the electrolyte membrane can be specified by elemental distribution analysis using, for example, an energy dispersive X-ray spectrometer (model “QUANTAX FlatQUAD”, manufactured by Bruker).

The above-mentioned distance T_{X} is determined based on the obtained elemental distribution.

As a method to arrange the platinum-containing material biased to one side of the electrolyte membrane, the above-described method may be employed. Specifically, for example, when the precursor membrane is obtained, the position of the arrangement of the film obtained by the present production method is adjusted.

Further, as a method to arrange the cerium oxide biased to one side of the electrolyte membrane, the same method as the method of arranging the platinum-containing material biased to one side of the electrolyte membrane may be employed.

It is preferred that the electrolyte membrane contains substantially no thickener because the use of a thickener leads to an increase of membrane resistance. When the electrolyte membrane contains substantially no thickener, it means that the content of the thickener is 0.1 mass % or less to the total mass of the electrolyte membrane. The content of the thickener is preferably 0.01 mass % or less, more preferably 0 mass %.

Specific examples of the thickener will be described later.

The thickness of the electrolyte membrane is preferably 30 μm or more, and is preferably 400 μm or less, more preferably 300 μm or less, further preferably 200 μm or less, particularly preferably 90 μm or less, most preferably 60 μm or less. In the case where the electrolyte membrane has a multilayer structure, the thickness of the electrolyte membrane refers to the total thickness of the respective layers.

In the case where the electrolyte membrane has a multilayer structure formed with the first electrolyte layer containing the platinum-containing material and the second electrolyte layer containing the platinum-containing material at a lower concentration than the first electrolyte layer or containing no platinum-containing material, the ratio of the thickness of the first electrolyte layer to the thickness of the second electrolyte layer (thickness of first electrolyte layer/thickness of second electrolyte layer) is preferably 0.02 or higher, more preferably 0.05 or higher, further preferably 0.12 or higher, particularly preferably 0.19 or higher, and is preferably 0.80 or lower, more preferably 0.50 or lower, further preferably 0.30 or lower.

The thickness of the electrolyte membrane is measured on a magnified cross-sectional image of the electrolyte membrane (e.g. at a magnification of 100) taken by an optical microscope (model “BX-51”, manufactured by Olympus Corporation). In the case where there are convex-concave parts on the surface of the electrolyte membrane, the thickness of the electrolyte membrane is an arithmetic mean of thickness measurements at total 20 points, i.e., 10 points on concave parts of the electrolyte membrane and 10 points on convex parts of the electrolyte membrane. In the case where yarns constituting the woven fabric are contained in convex parts of the electrolyte membrane, the thickness of such yarns is subtracted from the thickness of the convex parts.

The electrolyte membrane obtained by the present electrolyte membrane production method contains the additive.

In a case where the platinum-containing material is contained as the additive, when the electrolyte membrane is applied to a water electrolyzer, hydrogen generated at the cathode side and oxygen generated at the anode side react to form water on the platinum-containing material of the electrolyte membrane whereby the transfer of hydrogen to the anode side (hydrogen crossover) can be suppressed.

Further, in a case where the cerium oxide is contained as the additive, when the electrolyte membrane is applied to a water electrolyzer, OH radicals generated from hydrogen peroxide formed in the system during operation are quenched by cerium ions dissociated from the cerium oxide contained in the electrolyte membrane whereby decomposition of the fluorinated polymer (I) can be suppressed.

### [Membrane Electrode Assembly]

The polymer electrolyte membrane (the electrolyte membrane) obtained by the polymer electrolyte membrane production method of the present disclosure is suitable for a membrane electrode assembly.

The membrane electrode assembly contains the above-mentioned electrolyte membrane, a cathode catalyst layer provided on one surface of the electrolyte membrane and an anode catalyst layer provided on the other surface of the electrolyte membrane.

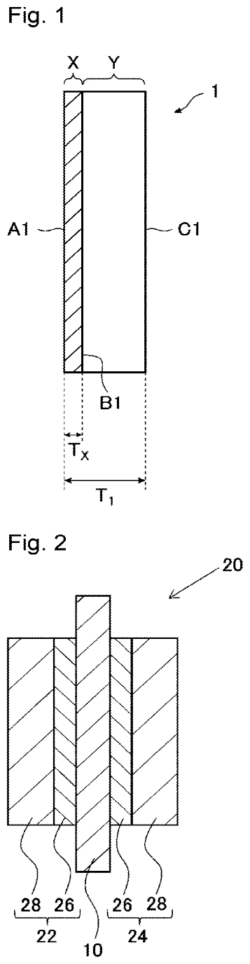

FIG. 2 is a cross-sectional view illustrating an example of the membrane electrode assembly. In the example of FIG. 2, a membrane electrode assembly 20 has an anode 22 with a catalyst layer 26 and a gas diffusion layer 28, a cathode 24 with a catalyst layer 26 and a gas diffusion layer 28, and an electrolyte membrane 10 disposed between the anode 22 and the cathode 24 in contact with the respective catalyst layers 26.

In the electrolyte membrane shown in FIG. 2, illustration of the woven fabric is omitted.

Although the electrolyte membrane has a single-layer structure in the example of FIG. 2, the electrolyte membrane may alternatively have a multilayer structure. Specific examples and preferred embodiments of the electrolyte membrane having a multilayer structure are the same as those described above.

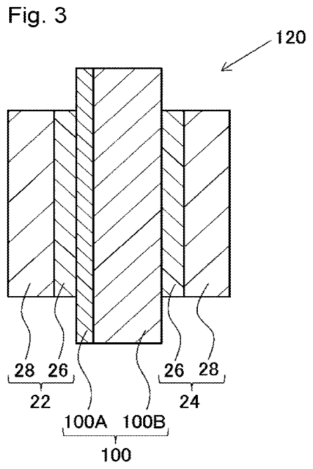

FIG. 3 is a cross-sectional view schematically illustrating an example of the membrane electrode assembly of the present disclosure in the case where the electrolyte membrane has a multilayer structure. The structure of a membrane electrode assembly 120 shown in FIG. 3 is similar to the structure of the membrane electrode assembly 20 shown in FIG. 2, except that an electrolyte membrane 100 is used in place of the electrolyte membrane 10 shown in FIG. 2. The electrolyte membrane 100 shown in FIG. 3 has a first electrolyte layer 100A and a second electrolyte layer 100B arranged in this order from the anode 22 side to the cathode 24 side.

In the electrolyte membrane shown in FIG. 3, illustration of the woven fabric is omitted.

The first electrolyte layer 100A contains the fluorinated polymer (I), the platinum-containing material and the cerium oxide.

The second electrolyte layer 100B contains the fluorinated polymer (I) and the cerium oxide. The second electrolyte layer 100B contains the platinum-containing material at a lower concentration than the first electrolyte layer or contains no platinum-containing material.

At least one of the first electrolyte layer 100A and the second electrolyte layer 100B contains the woven fabric.

Although the electrolyte membrane has a double-layer structure in the example of FIG. 3, the electrolyte membrane may have a structure of three or more layers.

In the example of FIG. 3, only the platinum-containing material is arranged biased to one side of the electrolyte membrane. In the electrolyte membrane contained in the membrane electrode assembly of the present disclosure, both of the platinum-containing material and the cerium oxide may be arranged biased to one side of the electrolyte membrane.

### <Anode and Cathode>

Each of the anode and the cathode has a catalyst layer. In the example of FIG. 2, each of the anode 22 and the cathode 24 has a catalyst layer 26 and a gas diffusion layer 28.

The catalyst layer may be, for example, a layer containing a catalyst and a polymer having ion exchange groups.

Specific examples of the catalyst include: a supported catalyst having platinum, a platinum alloy or a platinum-based core-shell catalytic material supported on a carbon carrier; an iridium oxide catalyst; a composite oxide catalyst containing iridium and a different metal element; an iridium oxide alloy-based catalyst; and an iridium oxide-based core-shell catalytic material. As the carbon carrier, a carbon black powder may be mentioned.

As the polymer having ion exchange groups, a fluorinated polymer having ion exchange groups may be mentioned, for example, the above-described fluorinated polymer (1) may be used.

The mass of the catalyst metal per 1 cm² of the catalyst layer is preferably 0.05 mg/cm² or more, more preferably more than 0.05 mg/cm², further preferably 0.2 mg/cm² or more, and is preferably 4 mg/cm² or less, more preferably 2 mg/cm² or less, further preferably 1 mg/cm² or less.

The mass ratio of the catalyst to the polymer having ion exchange groups (mass of catalyst/mass of polymer having ion exchange groups) in the catalyst layer is preferably 2 to 6.

The catalyst layer preferably contains a thickener from the viewpoint of dispersibility improvement and agglomeration suppression of the catalyst.

Specific examples of the thickener include urethane-based thickeners, polyacrylate-based thickeners, polyamide-based thickeners, cellulose-based thickeners and clay minerals such as bentonite. Further, ZEORORA (registered trademark) H (manufactured by Zeon Corporation) and the like are also usable as the thickener.

In the case where the catalyst layer contains a thickener, the content of the thickener to the total mass of the after-mentioned catalyst layer forming ink is preferably 2 mass % or more, more preferably 3 mass % or more, and is preferably 7 mass % or less, more preferably 6 mass % or less.

The gas diffusion layer functions to promptly diffuse gas generated from the catalyst layer to the outside of the catalyst layer, and also functions as a current collector. For example, the gas diffusion layer can be in the form of a carbon paper, a carbon cloth, a carbon felt, a sintered product of titanium oxide fiber, a sintered product of titanium oxide particles, or the like. In view of the facts that: the anode side is high in potential and carbon materials are oxidized during use, it is preferred to use a sintered product of titanium oxide fiber or a sintered product of titanium oxide particles. A sintered product of titanium oxide may be plated with platinum or the like as necessary.

The cathode gas diffusion layer may be made water repellent by applying PTFE or the like.

Although the membrane electrode assembly of FIG. 2 has gas diffusion layers 28, the gas diffusion layers are optional, and the membrane electrode assembly may have no gas diffusion layers.

The membrane thicknesses of the anode and the cathode are each independently preferably 5 μm or more, and is preferably 100 μm or less, more preferably 50 μm or less, further preferably 30 μm or less, particularly preferably 15 μm or less, with a view to obtaining more excellent effects of the present disclosure.

Each of the membrane thicknesses of the anode and the cathode is an arithmetic mean of thickness measurements at arbitrary 20 points in a cross-sectional image of the membrane electrode assembly cut in the membrane thickness direction taken by a laser microscope.

### <Membrane Electrode Assembly Production Method>

A membrane electrode assembly production method includes forming the cathode catalyst layer on one surface of the electrolyte membrane and forming the anode catalyst layer on the other surface of the electrolyte membrane.

For example, the membrane electrode assembly may be produced by using a laminate having the anode catalyst layer on a releasable base material (such as an ETFE sheet) and a laminate having the cathode catalyst layer on a releasable base material (such as an ETFE sheet), bonding the catalyst layers to both sides of the electrolyte membrane and peeling off the releasable base materials.

In each of the above-mentioned laminates, the gas diffusion layer may be provided between the catalyst layer and the releasable base material. In this case, the gas diffusion layer is arranged on the opposite side of the catalyst layer from the electrolyte membrane.

The catalyst layers may be formed by applying a catalyst layer forming ink to predetermined areas (such as surfaces of the releasable base materials), followed by drying as necessary. The catalyst layer forming ink is a dispersion of the polymer having ion exchange groups and the catalyst in a dispersion medium.

### <Applications>

The membrane electrode assembly is suitably applicable to, for example, a polymer electrolyte membrane water electrolyzer.

### [Water Electrolyzer]

The water electrolyzer preferably includes, for example, the above-mentioned membrane electrode assembly, a water supply unit for supplying water to the anode catalyst layer side and a power supply unit for electrical connection between the anode catalyst layer side and the cathode catalyst layer side.

In the above-described water electrolyzer, when a direct-current voltage is applied by the power supply unit in a state that water is supplied to the anode catalyst layer side by the water supply unit, water is decomposed into oxygen and protons by electrochemical reaction on the anode catalyst layer side. The protons transferring to the cathode catalyst layer side through the electrolyte membrane receive electrons to form hydrogen on the cathode catalyst layer side.

The water electrolyzer of the present disclosure may have the same configuration as that of a known water electrolyzer (for example, an oxygen recovery member to recover the generated oxygen and a hydrogen recovery member to recover the generated hydrogen) except that it has the above members.

### EXAMPLES

Now, the present invention will be described in further detail with reference to Examples. Ex. 1 to 9 correspond to Examples of the present invention, and Ex. 10 to 12 correspond to Comparative Examples. It should be understood that the present invention is by no means restricted thereto.

### [Ion Exchange Capacity of Fluorinated Polymer]

The weight of a fluorinated polymer was measured, after 24 hours of incubation in a glove box purged with dry nitrogen, as the dry mass of the fluorinated polymer. Then, the fluorinated polymer was immersed in a 2 mol/L aqueous sodium chloride solution at 60 °C for 1 hour. After the fluorinated polymer was washed with ultrapure water and recovered, the solution in which the fluorinated polymer had been immersed was titrated with 0.1 mol/L aqueous sodium hydroxide solution to determine the ion exchange capacity (meq/g dry resin) of the fluorinated polymer.

### [First Pellet Preparation Step]

First, the following fluorinated polymer having units based on tetrafluoroethylene and having groups convertible to ion exchange groups was obtained.

### <Production of Fluorinated Polymer (S′-3)>

CF₂═CF₂ and monomer (X1) represented by the following formula (X1) were copolymerized to obtain fluorinated polymer (S′-3) (ion exchange capacity: 1.25 meq/g resin). The blend ratio of the monomers was adjusted so that the fluorinated polymer (S′-3) would have the above ion exchange capacity.

CF₂═CF—O—CF₂CF(CF₃)—O—CF₂CF₂—SO₂F formula(X1):

### <Production of Fluorinated Polymer (S′-4)>

CF₂═CF₂ and monomer (X2) represented by the following formula (X2) were copolymerized to obtain fluorinated polymer (S′-4) (ion exchange capacity: 1.90 meq/g resin). The blend ratio of the monomers was adjusted so that the fluorinated polymer (S′-4) would have the above ion exchange capacity.

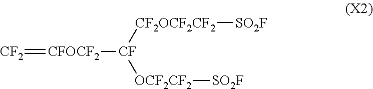

### <First Pellets 1>

To obtain first pellets 1, first, the above obtained fluorinated polymer (S′-3) was heated to 260 °C to melt, and passed through the following filter X1 (corresponding to the filter X).
Filter X1: metal mesh filter (#500, mesh opening: 0.026 mm)

The melt of the fluorinated polymer (S′-3) which had been passed through the filter X1 was supplied to a die heated to 260 °C and extruded to obtain a strand having a diameter of 3.0 mm. The obtained strand was cut into a length of 3.0 mm to obtain the first pellets 1.

The above procedure was conducted continuously by a melt-extruder.

### <First Pellets 2>

First pellets 2 were obtained in the same manner as the first pellets 1 except that the fluorinated polymer used was changed to the fluorinated polymer as identified in the following Table 1.

### <First Pellets D1>

First pellets D1 were obtained in the same manner as the preparation of the first pellets 1 except that the melt of the fluorinated polymer was not passed through a filter.

### [Second Pellet Preparation Step]

Using the above-obtained first pellets, second pellets were obtained. Procedures to obtain the respective second pellets will be described.

### <Second Pellets 1>

A melt containing the first pellets 1 obtained by the above procedure and an additive (the following platinum-containing material 1) was obtained.

Platinum-containing material 1: platinum black (manufactured by TANAKA PRECIOUS METAL TECHNOLOGIES Co., Ltd., “TEC90300”, D50: 14 um) (in Table 1, represented as “Pt black”).

The melt was obtained by supplying the first pellets 1 and the platinum-containing material 1 to a twin screw extruder (manufactured by the Japan Steel Works, Ltd.) at a heating temperature of 260 °C. The platinum-containing material 1 was supplied in an amount of 1.2 parts by mass based on the amount of the first pellets 1 supplied being 100 parts by mass.

Using the obtained melt, second pellets 1 were obtained in the same manner as the procedure to obtain the first pellets 1. For preparation of the second pellets 1, the following filter Y1 was used as the filter.
Filter Y1: metal mesh filter (mesh opening: 0.150 mm)

### <Second Pellets 2 to 6 and E1>

Second pellets 2 to 4 and second pellets E1 were obtained in the same manner as the preparation of the second pellets 1 except that the first pellets and the additive used and their amounts were changed as identified in the following Table 1, and that the filter was changed as identified in the following Table 1.

In the following Table 1, no description regarding the filter means that the second pellets were obtained without using a filter (without passing the melt through a filter).

For preparation of second pellets 4, the following cerium oxide was used.

Cerium oxide: cerium oxide (D50: 7 um) (represented as “CeO₂” in Table 1).

For preparation of second pellets 6, the following platinum-containing material 2 was used.

Platinum-containing material 2: platinum supported on carbon (D50: 0.1 um) (represented by “Pt/C” in Table 1).

### <Second Pellets E2>

Second pellets E2 were obtained in the same manner as the preparation of the second pellets 1 except that the amount of the additive used was changed as identified in the following Table 1.

### [Melt-Extrusion Step]

The melt-extrusion step was conducted using the first pellets and the second pellets obtained by the above procedure.

### <Ex. 1>

The first pellets 1 and the second pellets 1 were melted to obtain a melt of a mixture, which was melt-extruded to obtain a film.

Specifically, the first pellets 1 and the second pellets 1 were supplied to a melt-extruder, the melt of the mixture was obtained at a heating-mixing portion of the melt-extruder, and the melt of the mixture was extruded from a T-die to obtain film 1 having a thickness of 30 μm on a base material.

As the base material, a base material constituted by a linear low density polyethylene (LLDPE) film (melting point: 110 to 120 °C) was used.

The amounts of the first pellets 1 and the second pellets 1 supplied are as identified in “supply amount at film formation” in the following Table 1.

### <Ex. 2 to 10>

Films 2 to 10 were obtained by melt-extrusion in the same manner as in Ex. 1 except that the first pellets and the second pellets were used in the combination as identified in the following Table 1.

The amounts of the first pellets and the second pellets supplied are as defined in the following Table 1.

### <Ex. 11>

Film 8 was obtained by melt-extrusion in the same manner as in Ex. 1 except that only the second pellets E2 were used.

### <Ex. 12>

A film was to be obtained by melt-extrusion using only the second pellets E2 and passing the melt through the filter X1 used for the preparation of the first pellets 1.

As a result, the filter X1 was clogged, and a film could not be obtained.

### [Evaluation]

The obtained films were subjected to evaluation of pinholes by the following method.

With respect to the obtained films, the number of pinholes (perforations) was counted using a pinhole inspection apparatus (model “TRS-70”, manufactured by SANKO ELECTRONIC LABORATORY CO., LTD). As to whether occurrence of formation of pinholes was suppressed was evaluated based on the following standard. The grade A or B is preferred for practical application.
A: No pinhole
B: One to two pinholes
C: Three or more pinholes

### [Results]

The conditions for preparation of the first pellets and the second pellets, the film preparation conditions, and evaluation results are shown in Table 1.

In Ex. in which both the second pellets A and the second pellets B are described, two types of second pellets were used as the second pellets.

In Ex. 12, no film was obtained, and thus the above evaluation was not conducted.

In Table 1, “mesh opening/D50” refers to how many times the pore size of the filter Y relative to D50 of the additive described in Table 1. In Table 1, “mesh opening” refers to the pore size of each filter.

TABLE 1

| | | | | Ex. 1 | Ex. 2 | Ex. 3 | Ex. 4 | Ex. 5 | Ex. 6 |
|---|---|---|---|---|---|---|---|---|---|
| First | Type | | | 1 | 1 | 1 | 1 | 1 | 2 |
| pellets | Fluorinated | Type | | S′-3 | S′-3 | S′-3 | S′-3 | S′-3 | S′-4 |
| | polymer | | | | | | | | |
| | Filter X | Type | | #500 | #500 | #500 | #500 | #500 | #500 |
| | | Mesh opening | mm | 0.026 | 0.026 | 0.026 | 0.026 | 0.026 | 0.026 |
| | Supply amount at film formation | | parts by mass | 80 | 80 | 80 | 80 | 70 | 80 |
| Second | Type | | | 1 | 2 | 3 | 1 | 1 | 5 |
| pellets A | Platinum- | Type | | Pt black | Pt black | Pt black | Pt black | Pt black | Pt black |
| | containing | D50 | μm | 14 | 30 | 7 | 14 | 14 | 14 |
| | material | Amount added | parts by mass | 1.2 | 1.2 | 1.2 | 1.2 | 1.2 | 1.2 |
| | Cerium oxide | Type | | — | — | — | — | — | — |
| | | D50 | μm | — | — | — | — | — | — |
| | | Amount added | | — | — | — | — | — | — |
| | First pellets | Type | | 1 | 1 | 1 | 1 | 1 | 2 |
| | | Amount added | parts by mass | 100 | 100 | 100 | 100 | 100 | 100 |
| | Filter Y | Type | | #100 | #50 | #200 | #50 | #100 | #100 |
| | | Mesh opening | mm | 0.15 | 0.32 | 0.077 | 0.32 | 0.15 | 0.15 |
| | | Mesh opening/D50 | | 10.7 | 10.7 | 11.0 | 22.9 | 10.7 | 10.7 |
| | Supply amount at film formation | | parts by mass | 20 | 20 | 20 | 20 | 20 | 20 |
| Second | Type | | | — | — | — | — | 4 | — |
| pellets B | Cerium oxide | Type | | — | — | — | — | CeO₂ | — |
| | | D50 | μm | — | — | — | — | 7 | — |
| | | Amount added | | — | — | — | — | 7 | — |
| | First pellets | Type | | — | — | — | — | 1 | — |
| | | Amount added | parts by mass | — | — | — | — | 100 | — |
| | Filter Y | Type | | — | — | — | — | #100 | — |
| | | Mesh opening | mm | — | — | — | — | 0.15 | — |
| | | Mesh opening/D50 | | — | — | — | — | 21.4 | — |
| | Supply amount at film formation | | parts by mass | — | — | — | — | 10 | — |
| Evaluation | Pinholes | | | A | B | A | B | B | A |
| | | | | Ex. 7 | Ex. 8 | Ex. 9 | Ex. 10 | Ex. 11 | Ex. 12 |
| First | Type | | | 1 | 1 | 1 | D1 | — | — |
| pellets | Fluorinated | Type | | S′-3 | S′-3 | S′-3 | S′-3 | — | — |
| | polymer | | | | | | | | |
| | Filter X | Type | | #500 | #500 | #500 | — | — | — |
| | | Mesh opening | mm | 0.026 | 0.026 | 0.026 | — | — | — |
| | Supply amount at film formation | | parts by mass | 80 | 80 | 80 | 80 | — | — |
| Second | Type | | | 1 | 6 | 1 | E1 | E2 | E2 |
| pellets A | Platinum- | Type | | Pt black | Pt/C | Pt black | Pt black | Pt black | Pt black |
| | containing | D50 | μm | 14 | 0.1 | 14 | 14 | 14 | 14 |
| | material | Amount added | parts by mass | 1.2 | 1.2 | 1.2 | 1.2 | 0.24 | 0.24 |
| | Cerium oxide | Type | | — | — | CeO₂ | — | — | — |
| | | D50 | μm | — | — | 7 | — | — | — |
| | | Amount added | | — | — | 7 | — | — | — |
| | First pellets | Type | | 1 | 1 | 1 | D1 | D1 | D1 |
| | | Amount added | parts by mass | 100 | 100 | 100 | 100 | 100 | 100 |
| | Filter Y | Type | | — | #100 | #100 | — | — | #500 |
| | | Mesh opening | mm | — | 0.15 | 0.15 | — | — | 0.026 |
| | | Mesh opening/D50 | | — | 1500 | 21.4 | — | — | 1.9 |
| | Supply amount at film formation | | parts by mass | 20 | 20 | 20 | 20 | 100 | 100 |
| Second | Type | | | — | — | — | — | — | — |
| pellets B | Cerium oxide | Type | | — | — | — | — | — | — |
| | | D50 | μm | — | — | — | — | — | — |
| | | Amount added | | — | — | — | — | — | — |
| | First pellets | Type | | — | — | — | — | — | — |
| | | Amount added | parts by mass | — | — | — | — | — | — |
| | Filter Y | Type | | — | — | — | — | — | — |
| | | Mesh opening | mm | — | — | — | — | — | — |

| | | | | | | |
|---|---|---|---|---|---|---|
| Mesh opening/D50 | — | — | — | — | — | — |

| | | | | | | | |
|---|---|---|---|---|---|---|---|
| Supply amount at film formation | parts by mass | — | — | — | — | — | — |

| | | | | | | | |
|---|---|---|---|---|---|---|---|
| Evaluation | Pinholes | B | A | B | C | C | — |

As shown in Table 1, it was confirmed from the comparison between Ex. 10 to 12 and Ex. 1 to 9 that formation of pinholes is suppressed by obtaining a film in such a manner that the first pellets are prepared by passing the melt through the filter X, the second pellets are obtained from the first pellets by the predetermined procedure, and melt-extrusion is conducted using the first pellets and the second pellets.

Further, it was confirmed from the comparison between Ex. 1 and Ex. 4 that a film with further suppressed formation of pinholes is obtained when, in a case where the platinum-containing material having a D50 of 500 nm or more is contained, the pore size of the filter Y is equal to or smaller than 20 times D50.

It was confirmed from the comparison between Ex. 1 and Ex. 2 that a film with further suppressed formation of pinholes is obtained when the pore size of the filter Y is 0.30 mm or less.

### [Production of Polymer Electrolyte Membrane]

A polymer electrolyte membrane was produced by using the film 1 obtained in Ex. 1 and woven fabric A1, which will be described in detail below.

Specifically, a film-provided base material having the above film 1, woven fabric A1 and a film-provided base material having the above film 1 were stacked in this order. The film-provided base materials were arranged so that the film 1 in each film-provided base material was in contact with the woven fabric A1.

The stacked members were thermally press-bonded together by a flat press machine at a temperature of 160 °C and a surface pressure of 30 MPa/m² for 10 minutes, and then, the base materials on both sides were peeled off at a temperature of 50 °C to obtain a precursor membrane.

The precursor membrane was immersed in a solution of dimethyl sulfoxide/potassium hydroxide/water=30/5.5/64.5 (mass ratio) at 95 °C for 30 minutes to convert groups convertible to sulfonic acid functional groups in the precursor membrane by hydrolysis to K-form sulfonic acid functional groups, and washed with water. The thus-obtained membrane was immersed in 1M sulfuric acid to convert the terminal groups from K-form to H-form, and dried to obtain electrolyte membrane 1 (thickness: 90 μm) of Ex. 1.

The obtained electrolyte membrane was subjected to evaluation of pinholes in the same manner as the films and got the grade A.

### <Woven Fabric>

Using 18.6-denier yarns of PFA as warp yarns and weft yarns, woven fabric A1 was produced by plain weaving such that the density of the PFA yarns was 100 yarns/inch. The fabric weight of the woven fabric A1 was 16.3 g/m². The warp yarns and weft yarns used were in the form of slit yarns.

This application is a continuation of PCT Application No. PCT/JP2024/046042, filed on Dec. 25, 2024, which is based upon and claims the benefit of priority from Japanese Patent Application No. 2023-222993 filed on Dec. 28, 2023. The contents of those applications are incorporated herein by reference in their entireties.

### REFERENCE SYMBOLS

1, 10, 100: electrolyte membrane
20, 120: membrane electrode assembly
22: anode
24: cathode
26: catalyst layer
28: gas diffusion layer
100A: first electrolyte layer
100B: second electrolyte layer
A1, C1: surface
B1: depth position
T₁, T_{X}: distance
X, Y: region

What is claimed is:

1. A film production method, which comprises melting a fluorinated polymer having units based on tetrafluoroethylene and having groups convertible to ion exchange groups, and passing the melt through a filter X to prepare first pellets,
using the first pellets and at least one type of additive selected from the group consisting of a platinum-containing material and cerium oxide to obtain a melt containing the additive and the fluorinated polymer, and not passing the melt through a filter or passing the melt through a filter Y having a pore size larger than 5 times the volume-based cumulative 50% size of the additive, to prepare second pellets containing the additive, and
conducting melt-extrusion using the first pellets and the second pellets to produce a film containing the fluorinated polymer and the additive.

2. The film production method according to claim 1, wherein the second pellets contain both the platinum-containing material and the cerium oxide.

3. The film production method according to claim 1, wherein in the melt-extrusion, two or more types of the second pellets are used,
at least one type of the second pellets contain only the platinum-containing material, and
at least one type of the second pellets contain only the cerium oxide.

4. The film production method according to claim 1, wherein the platinum-containing material is supported on a carrier.

5. The film production method according to claim 1, wherein the platinum-containing material has a volume-based cumulative 50% size of 500 nm or more.

6. The film production method according to claim 1, wherein the pore size of the filter Y is equal to or smaller than 20 times the volume-based cumulative 50% size of the additive.

7. The film production method according to claim 1, wherein the groups convertible to ion exchange groups are groups convertible to sulfonic acid functional groups.

8. The film production method according to claim 7, wherein the fluorinated polymer has at least one type of units selected from the group consisting of units based on a compound represented by the formula (2-3) and units based on a compound represented by the formula (2-4): 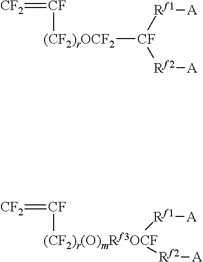
in the formulae (2-3) and (2-4), R^{f1} is a perfluoroalkylene group which may contain an oxygen atom between carbon atoms, R^{f2} is a single bond or a perfluoroalkylene group which may contain an oxygen atom between carbon atoms;
in the formula (2-4), R^{f3} is a single bond or a perfluoroalkylene group which may contain an oxygen atom between carbon atoms;
in the formulae (2-3) and (2-4), r is 0 or 1, and the two A are each independently a group convertible to a sulfonic acid functional group;
in the formula (2-4), m is 0 or 1.

9. A polymer electrolyte membrane production method, which comprises producing a film by the film production method as defined in claim 1,
obtaining a precursor membrane that is a laminate of the film and a woven fabric, and
converting the groups convertible to ion exchange groups in the precursor membrane to ion exchange groups to obtain a polymer electrolyte membrane.
